(19) United States
(12) Patent Application Publication
(10) Pub. No.: US 2025/0182403 A1
(43) Pub. Date: Jun. 5, 2025

(54) THREE-DIMENSIONAL MODELING METHOD, SYSTEM, APPARATUS, DEVICE, AND STORAGE MEDIUM

(71) Applicant: Tencent Technology (Shenzhen) Company Limited, Shenzhen (CN)

(72) Inventors: Cheng Lin, Shenzhen (CN); Fan Yang, Shenzhen (CN); Zijiao Zeng, Shenzhen (CN)

(21) Appl. No.: 19/050,332

(22) Filed: Feb. 11, 2025

Related U.S. Application Data
(63) Continuation of application No. PCT/CN2023/128474, filed on Oct. 31, 2023.

(30) Foreign Application Priority Data
Feb. 24, 2023 (CN) 2023101614885

(51) Int. Cl. G06T 17/20; G06T 3/4038; G06T 7/55

(52) U.S. Cl. CPC G06T 17/205; G06T 3/4038; G06T 7/55

(57) ABSTRACT

A three-dimensional modeling method, apparatus, and storage medium is described herein. The method includes: obtaining a planar image set of a to-be-modeled object, obtaining boundary information of the to-be-modeled object performing depth prediction processing on each of the planar images in the planar image set, to obtain depth information of the to-be-modeled object, and modeling the to-be-modeled object based on the boundary information of the to-be-modeled object and the depth information of the to-be-modeled object, to obtain a three-dimensional model of the to-be-modeled object.

### RELATED APPLICATION

This application is a continuation application of PCT Application PCT/CN2023/128474, filed Oct. 31, 2023, which claims priority to Chinese Patent Application No. 2023101614885 filed on Feb. 24, 2023, each entitled “THREE-DIMENSIONAL MODELING METHOD AND APPARATUS, DEVICE, AND STORAGE MEDIUM”, and each which is incorporated herein by reference in its entirety.

### FIELD OF THE TECHNOLOGY

This application relates to the field of computer technologies, and specifically, to a three-dimensional modeling method, a three-dimensional modeling apparatus, a three-dimensional modeling system, a three-dimensional modeling computer device, and a three-dimensional modeling computer-readable storage medium.

### BACKGROUND OF THE DISCLOSURE

With the progress of science and technology research, three-dimensional models are widely applied to various fields of life, for example, a game field, a design field, and a video field. A manner of generating a three-dimensional model of a target object may include generating the three-dimensional model of the target object by using a planar image of the target object. Research has found that a three-dimensional model directly modeled based on a planar image of a target object has poor quality (such as a low restoration degree).

### SUMMARY

One or more aspects described herein provide a three-dimensional modeling method, apparatus, system, and computer-readable storage medium, which can improve quality of a three-dimensional model.
one or more aspects described herein provide a three-dimensional modeling method, including:
obtaining a planar image set of a to-be-modeled object, the planar image set comprising a first planar image of a first object element of the to-be-modeled object from a first perspective and a second planar image of the first object element of the to-be-modeled object from a second perspective that is different from the first perspective;
obtaining boundary information of the to-be-modeled object, the boundary information comprising first boundary information of the first object element, the first boundary information comprising first geometric boundary annotation information and second geometric boundary annotation information, the first geometric boundary annotation information indicating a first actual boundary of the first object element of the to-be-modeled object in the first planar image, and the second geometric boundary annotation information indicating a second actual boundary of the first object element of the to-be-modeled object in the second planar image;
performing depth prediction processing on the first planar image and the second planar image, to obtain depth information of the to-be-modeled object, the depth information comprising first depth information of the first object element; and
modeling the to-be-modeled object based on the boundary information of the to-be-modeled object and the depth information of the to-be-modeled object, to generate a three-dimensional model of the to-be-modeled object.

One or more aspects described herein provide a three-dimensional modeling apparatus, the three-dimensional modeling apparatus comprising one or more processors; and memory storing computer-readable instructions that when executed by the one or more processors, cause the three-dimensional modeling apparatus to:
obtain a planar image set of a first object element of a to-be-modeled object, the planar image set comprising a first planar image of the to-be-modeled object from a first perspective and a second planar image of the to-be-modeled object from a second perspective that is different from the first perspective;
obtain boundary information of the to-be-modeled object, the boundary information comprising first boundary information of the first object element, the first boundary information comprising first geometric boundary annotation information and second geometric boundary annotation information, the first geometric boundary annotation information indicating a first actual boundary of the first object element of the to-be-modeled object in the first planar image, and the second geometric boundary annotation information indicating a second actual boundary of the first object element of the to-be-modeled object in the second planar image;
perform depth prediction processing on the first planar image and the second planar image, to obtain depth information of the to-be-modeled object, the depth information comprising first depth information of the first object element; and
model the to-be-modeled object based on the boundary information of the to-be-modeled object and the depth information of the to-be-modeled object, to generate a three-dimensional model of the to-be-modeled object

The first depth information of the to-be-modeled object comprises depth information of a pixel point associated with the first object element in each planar image of the planar image set. The modeling comprises restoring a position of the pixel point associated with the to-be-modeled object in a three-dimensional space based on the depth information of the pixel point associated with the to-be-modeled object in each planar image; and performing stitching processing on the first actual boundary and the second actual boundary, to obtain a three-dimensional boundary line of the to-be-modeled object. The stitching processing comprises connecting the pixel points in the three-dimensional space corresponding to the first actual boundary and the second actual boundary of the first object element of the to-be-modeled object indicated by the first geometric boundary annotation information and the second geometric boundary annotation information in series and generating the three-dimensional model of the to-be-modeled object through the three-dimensional boundary line of the to-be-modeled object.

The three-dimensional model of the to-be-modeled object may be generated through the three-dimensional boundary line of the to-be-modeled object, and may comprise determining a mesh template corresponding to the to-be-modeled object based on topology classification of the three-dimensional boundary line of the to-be-modeled object; and cutting the mesh template corresponding to the to-be-modeled object based on the three-dimensional boundary line of the to-be-modeled object, to obtain the three-dimensional model of the to-be-modeled object.

The three-dimensional modeling apparatus may further:
obtain a smoothness constraint condition of the mesh template corresponding to the to-be-modeled object and a restoration degree constraint condition of the to-be-modeled object;
predict a mesh deformation parameter corresponding to the to-be-modeled object based on a position of the to-be-modeled object in the three-dimensional space, the smoothness constraint condition of the mesh template corresponding to the to-be-modeled object, and the restoration degree constraint condition of the to-be-modeled object; and
perform model optimization processing on the three-dimensional model of the to-be-modeled object based on the mesh deformation parameter corresponding to the to-be-modeled object, to obtain a three-dimensional model after the model optimization processing.

The to-be-modeled object comprises a second object element, the planar image set comprises a third planar image of the second object element from the first perspective and a fourth planar image of the second object element from the second perspective, the boundary information of the to-be-modeled object comprises second geometric boundary annotation information corresponding to the second object element, the second geometric boundary annotation information indicating a third actual boundary of the second object element in the third planar image and a fourth actual boundary of the second object element in the fourth planar image, the depth information of the to-be-modeled object comprises second depth information for the second object element.

The three-dimensional modeling apparatus may model the to-be-modeled object based on the boundary information of the to-be-modeled object and the depth information of the to-be-modeled object, to obtain a three-dimensional model of the to-be-modeled object, and is further configured to:
obtain a first matching relationship between the first planar image and the second planar image and a second matching relationship between the third planar image and the fourth planar image;
determine first boundary information corresponding to the first object element based on the first matching relationship;
determine second boundary information corresponding to the second object element based on the second matching relationship;
model the first object element based on the first boundary information of the first object element and the first depth information of the first object element, to obtain a first three-dimensional model of the first object element;
model the second object element based on the second boundary information of the second object element and the second depth information of the second object element, to obtain a second three-dimensional model of the second object element; and
stack the first three-dimensional model of the first object element and the second three-dimensional model of the second object element, to obtain the three-dimensional model of the to-be-modeled object.

The first planar image is a front view of the to-be-modeled object, the second planar image is a back view of the to-be-modeled object. The three-dimensional modeling apparatus may obtain the first matching relationship by;
performing view transformation processing on the first and second planar images from the first perspective based on the second perspective, to obtain a first transformed view; and
determining a matching relationship between the first planar image and the second planar image based on a similarity between a boundary of the first object element in the first transformed view and a boundary of the first object element in the second planar image.

The first object element is associated with a first layer identifier indicating a first display priority of the first object element, the second object element is associated with a second layer identifier indicating a second display priority of the second object element, and the three-dimensional modeling apparatus may:
determine, based on the first layer identifier and the second layer identifier, that the first three-dimensional model has a higher display priority than the second three-dimensional model; and
display, in the overlapping region, the first three-dimensional model based on its higher display priority.
the first object element is associated with a first layer identifier indicating a first display priority of the first object element, the second object element is associated with a second layer identifier indicating a second display priority of the second object element, and if it is detected that the first three-dimensional model of the first object element and the second three-dimensional model of the second object element are interlaced with each other, the three-dimensional modeling apparatus may:
perform mesh optimization processing on a first mesh in the first three-dimensional model based on the first layer identifier and the second layer identifier, to obtain a three-dimensional model of the to-be-modeled object,
wherein the mesh optimization processing removes interlacing between the first three-dimensional model and the second three-dimensional model.

In an implementation, the first depth information of the to-be-modeled object is obtained by performing the depth prediction processing on the first planar image and the second planar image by using a depth prediction model, and a training process of the depth prediction model includes:
performing, by the depth prediction model, depth prediction processing on a target pixel point associated with a target object in a training image, to obtain a depth prediction result corresponding to the target pixel point;
predicting a normal vector of each target pixel point based on the depth prediction result of each target pixel point; and
jointly optimizing the depth prediction model based on depth difference information and normal vector difference information, to obtain an optimized depth prediction model, the depth difference information being obtained based on a difference between the depth prediction result of each target pixel point and an annotation result corresponding to the training image, and the normal vector difference information being obtained based on a difference between the predicted normal vector of each target pixel point and a true normal vector of the target pixel point.

In an implementation, the three-dimensional modeling apparatus may obtain boundary information of a to-be-modeled object, and is specifically configured to:
perform boundary detection on the first planar image to obtain a first boundary of the first object element in the first planar image;
perform boundary detection on the second planar image to obtain a second boundary of the first object element in the second planar image;
perform identification processing on the first boundary by using a geometric boundary identification model, to obtain first geometric boundary annotation information corresponding to the first planar image; and
perform identification processing on the second boundary by using the geometric boundary identification model, to obtain second geometric boundary annotation information corresponding to the second planar image.

Further described herein is a computer device, the computer device including:
a memory, having a computer program stored therein; and
a processor, configured to load the computer program to implement the foregoing three-dimensional modeling method.

Further described herein is a computer-readable storage medium. The computer-readable storage medium has a computer program stored therein, the computer program being adapted to be loaded and executed by a processor to implement the foregoing three-dimensional modeling method.

Further described herein is a computer program product or a computer program, the computer program product or the computer program including a computer instruction, the computer instruction being stored in a computer-readable storage medium. A processor of a computer device reads the computer instruction from the computer-readable storage medium, and the processor executes the computer instruction, so that the computer device performs the foregoing three-dimensional modeling method.

The planar image set of the to-be-modeled object may be obtained, the planar image set including planar images of the to-be-modeled object from different perspectives. The boundary information of the to-be-modeled object is obtained, the boundary information being configured for indicating the actual boundary of the to-be-modeled object in the planar image. Depth prediction processing is performed on each of the planar images in the planar image set, to obtain depth information of the to-be-modeled object. The to-be-modeled object is modeled based on the boundary information of the to-be-modeled object and the depth information of the to-be-modeled object, to obtain a three-dimensional model of the to-be-modeled object. It can be seen that a modeling process of the to-be-modeled object is constrained through the depth information of the to-be-modeled object and the boundary information of the to-be-modeled object, thereby improving quality of the three-dimensional model of the to-be-modeled object.

### BRIEF DESCRIPTION OF THE DRAWINGS

To describe the technical solutions more clearly, the accompanying drawings are briefly described below. The accompanying drawings in the following description show one or more aspects described herein, and a person of ordinary skill in the art may still derive other accompanying drawings from these accompanying drawings without creative efforts.

FIG. 1 is a schematic diagram of a three-dimensional modeling scheme according to one or more aspects described herein.

FIG. 2 is a flowchart of a three-dimensional modeling method according to one or more aspects described herein.

FIG. 3 is a front view of a to-be-modeled object according to one or more aspects described herein.

FIG. 4 is a schematic diagram of a common topology type according to one or more aspects described herein.

FIG. 5 is a flowchart of another three-dimensional modeling method according to one or more aspects described herein.

FIG. 6 is a frame diagram of a three-dimensional modeling process according to one or more aspects described herein.

FIG. 7 is a schematic diagram of a management page of a three-dimensional modeling plug-in according to one or more aspects described herein.

FIG. 8 is a schematic structural diagram of a three-dimensional modeling apparatus according to one or more aspects described herein.

FIG. 9 is a schematic structural diagram of a computer device according to one or more aspects described herein.

### DETAILED DESCRIPTION

Technical solutions are clearly described below with reference to accompanying drawings. All other aspects obtained by a person of ordinary skill in the art based on the description provided herein and in the accompanying drawings without creative efforts fall within the protection scope of the one or more aspects described herein.

One or more aspects described herein relate to artificial intelligence (AI) and computer vision (CV) technologies. The following briefly describes the AI and CV technologies:

AI: AI is a theory, a method, a technology, and an application system that uses a digital computer or a machine controlled by the digital computer to simulate, extend, and expand human intelligence, perceive the environment, acquire knowledge, and use the knowledge to obtain the best result. In other words, AI is a comprehensive technology of computer science, which attempts to understand essence of intelligence and produces a new intelligent machine that can respond in a manner similar to human intelligence. The AI is to study the design principles and implementation methods of various intelligent machines, to enable the machines to have functions of sensing, reasoning, and decision-making. One or more aspects described herein involve performing depth prediction processing on a planar image including a to-be-modeled object through a depth prediction model, to obtain depth information of the to-be-modeled object.

The AI technology is a comprehensive discipline, and involves a wide range of fields including both the hardware-level technology and the software-level technology. The basic AI technologies generally include technologies such as a sensor, a dedicated AI chip, cloud computing, distributed storage, a large application processing technology, an operating/interaction system, and electromechanical integration. AI software technologies mainly include several major directions such as a CV technology, a speech processing technology, a natural language processing technology, and machine learning/deep learning.

CV: The CV is a science that studies how to use a machine to “see”, and furthermore, that uses a camera and a computer to replace human eyes to perform machine vision such as recognition, following, and measurement on a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. The CV technology generally includes technologies such as image processing, image recognition, image semantic understanding, image retrieval, optical character recognition (OCR), video processing, video semantic understanding, video content/behavior recognition, three-dimensional object reconstruction, 3D technology, virtual reality, augmented reality, and simultaneous localization and mapping, and further includes common biometric recognition technologies such as face recognition and fingerprint recognition. One or more aspects described herein mainly relate to constructing a three-dimensional model of a to-be-modeled object through planar images of the to-be-modeled object from different perspectives and boundary information of the to-be-modeled object in each planar image.

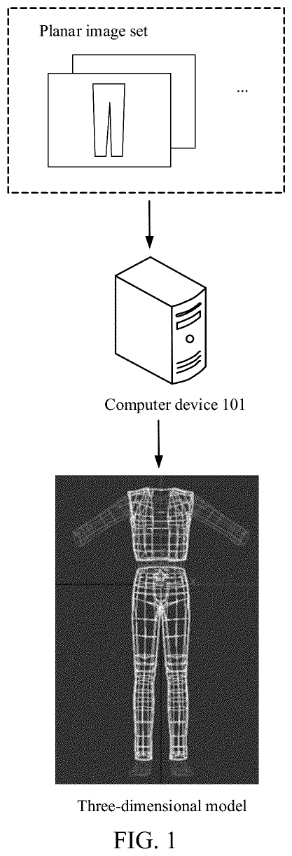

Based on the AI and CV technologies, one or more aspects described herein provide a three-dimensional modeling scheme, to improve quality of a three-dimensional model generated based on a planar image. FIG. 1 is a schematic diagram of a three-dimensional modeling scheme according to one or more aspects described herein. As shown in FIG. 1, the three-dimensional modeling scheme may be performed by a computer device 101. The computer device 101 herein may be a terminal or a server having a three-dimensional modeling capability. The terminal may include but is not limited to: a device having a three-dimensional modeling capability, such as a smartphone (such as an Android phone or an IOS phone), a tablet computer, a portable personal computer, a mobile Internet device (MID), an on-board terminal, a smart home appliance, an unmanned aerial vehicle, or a wearable device, and/or the like. The server may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), and a big data and AI platform, and/or the like.

A quantity of computer devices in FIG. 1 is merely used as an example, and does not constitute an actual limitation. For example, a three-dimensional modeling system may further include a computer device 102, a terminal device 103, or a server 104.

During specific implementation, a general principle of the three-dimensional modeling scheme may be as follows.
(1) The computer device 101 may obtain a planar image set of a to-be-modeled object, the planar image set including a first planar image and a second planar image, the first planar image and the second planar image being planar images of the to-be-modeled object from different perspectives. The to-be-modeled object may specifically be a piece of clothing, an ornament, a commodity, a game prop, or the like, which is not limited. In subsequent descriptions, an example in which the to-be-modeled object is clothing is used for description. The planar image set may include at least two of the following planar images: a front view of the to-be-modeled object, a back view of the to-be-modeled object, a top view of the to-be-modeled object, a left view of the to-be-modeled object, or a right view of the to-be-modeled object. The planar images required for modeling of different to-be-modeled objects may be the same or different. For example, when the to-be-modeled object is a piece of clothing, the planar image set may include a front view and a back view of the clothing. When the to-be-modeled object is a water cup, the planar image set may include a front view and a top view of the water cup. When the to-be-modeled object is a vehicle, the planar image set may include a front view, a top view, a left view, and a back view of the vehicle.
(2) The computer device 101 may obtain boundary information of the to-be-modeled object, the boundary information including first geometric boundary annotation information and second geometric boundary annotation information, the first geometric boundary annotation information indicating an actual boundary of the to-be-modeled object in the first planar image, and the second geometric boundary annotation information indicating an actual boundary of the to-be-modeled object in the second planar image.

Specifically, a boundary (contour) of the to-be-modeled object in the planar image may include a visual boundary and an actual boundary. The actual boundary of the to-be-modeled object refers to a boundary objectively existing in the to-be-modeled object (or a three-dimensional model of the to-be-modeled object), the boundary being not affected by an observation perspective. In other words, no matter from which perspective the to-be-modeled object (or the three-dimensional model of the to-be-modeled object) is observed, the actual boundary of the to-be-modeled object objectively exists. For example, for a piece of clothing, an actual boundary of the clothing may include a collar and a cuff. The visual boundary of the to-be-modeled object refers to a boundary other than an actual boundary among boundaries (contours) of the to-be-modeled object in a planar image from a perspective when the to-be-modeled object (or a three-dimensional model of the to-be-modeled object) is observed from the perspective. The visual boundary of the to-be-modeled object is not a boundary that objectively exists. In other words, the visual boundary changes (for example, disappears) with a change of the observation perspective.
(3) The computer device 101 may perform depth prediction processing on each of the planar images in the planar image set, to obtain depth information of the to-be-modeled object. The depth information of the to-be-modeled object includes depth information of associated pixel points of the to-be-modeled object in each planar image. The depth information of the to-be-modeled object may include first depth information and second depth information, the first depth information being obtained by the computer device 101 by performing depth prediction processing on the first planar image, and the second depth information being obtained by the computer device 101 by performing depth prediction processing on the second planar image.

The computer device 101 may perform depth prediction processing on each of the planar images in the planar image set through a depth prediction model, to obtain the depth information of the to-be-modeled object outputted by the depth prediction model.
(4) The computer device 101 may model the to-be-modeled object based on the boundary information of the to-be-modeled object and the depth information of the to-be-modeled object, to obtain a three-dimensional model of the to-be-modeled object. The depth information of the to-be-modeled object includes depth information of associated pixel points (for example, pixel points for representing the to-be-modeled object in a planar image) of the to-be-modeled object in each planar image of the planar image set. The computer device 101 may restore a position of the pixel point associated with the to-be-modeled object in a three-dimensional space based on the depth information of the pixel point associated with the to-be-modeled object in each planar image. After the position of the pixel point associated with the to-be-modeled object in the three-dimensional space is obtained, the computer device may perform stitching processing on the pixel points in the three-dimensional space based on the first geometric boundary annotation information and the second geometric boundary annotation information, to obtain a three-dimensional boundary line of the to-be-modeled object. The three-dimensional boundary line of the to-be-modeled object may indicate an actual boundary of the to-be-modeled object in the three-dimensional space. After obtaining the three-dimensional boundary line of the to-be-modeled object, the computer device 101 may generate a three-dimensional model of the to-be-modeled object through the three-dimensional boundary line of the to-be-modeled object.

A modeling process of the to-be-modeled object may be constrained through planar images of object elements of the to-be-modeled object from at least two perspectives and based on depth information corresponding to each planar image and boundary information of the to-be-modeled object, which may improve quality of the three-dimensional model of the to-be-modeled object, thereby omitting some operations of artificial three-dimensional modeling, and improving modeling efficiency of the three-dimensional model.

Based on the foregoing three-dimensional modeling scheme, one or more aspects described herein provide a more detailed three-dimensional modeling method. The three-dimensional modeling method is described in detail below with reference to the accompanying drawings.

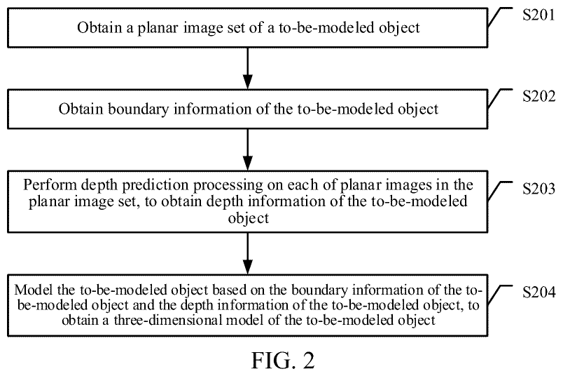

FIG. 2 is a flowchart of a three-dimensional modeling method according to one or more aspects described herein. The three-dimensional modeling method may be performed by a computer device. The computer device may be a terminal device or a server. As shown in FIG. 2, the three-dimensional modeling method may include the following operations S201-S204.

S201: Obtain a planar image set of a to-be-modeled object.

The planar image set may include a first planar image and a second planar image of the to-be-modeled object, the first planar image and the second planar image being planar images of the to-be-modeled object from different perspectives. The planar image set may further include a third planar image of the to-be-modeled object, and an observation perspective corresponding to the third planar image may be different from observation perspectives corresponding to the first planar image and the second planar image.

The to-be-modeled object may include one object element. In other words, the object element may be the to-be-modeled object. In this case, the planar image set may include a first planar image and a second planar image of the object element.

In another example, the to-be-modeled object may include M object elements, M being an integer greater than 1. For example, the to-be-modeled object may include a shirt (a first object element) and a coat (a second object element). In this case, the planar image set may include a first planar image and a second planar image of each of the M object elements. For example, assuming that M=2, a planar image set of a to-be-modeled object may include a first planar image and a second planar image of the first object element, and a first planar image and a second planar image of a second object element.

An observation perspective corresponding to the first planar image of each of the M object elements may be the same, and an observation perspective corresponding to the second planar image of each object element may also be the same. In this case, the first planar image and the second planar image of the to-be-modeled object may be obtained by stacking the first planar images and the second planar images of the M object elements based on a layer sequence.

An observation perspective corresponding to a first planar image (or a second planar image) of at least one of the M object elements may be different from an observation perspective corresponding to a first planar image of another object element, and may also be different from an observation perspective corresponding to a second planar image of the another object element. For example, assuming that the M object elements include a shirt, a coat, pants, and a shoe (that is, M=4), first planar images of the shirt, the coat, and the pants may all be front views, and second planar images thereof may all be back views. A first planar image of the shoe may be a front view, and a second planar image thereof may be a top view.

S202: Obtain boundary information of the to-be-modeled object.

The boundary information may include first geometric boundary annotation information and second geometric boundary annotation information, the first geometric boundary annotation information indicating an actual boundary of the to-be-modeled object in the first planar image, and the second geometric boundary annotation information indicating an actual boundary of the to-be-modeled object in the second planar image.

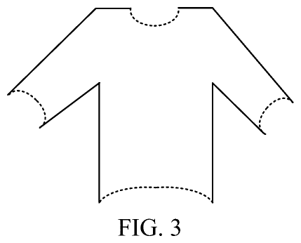

Specifically, a boundary (contour) of the to-be-modeled object in the planar image may include a visual boundary and an actual boundary. The actual boundary of the to-be-modeled object refers to a boundary objectively existing in the to-be-modeled object (or a three-dimensional model of the to-be-modeled object). The visual boundary of the to-be-modeled object refers to a boundary other than an actual boundary among boundaries (contours) of the to-be-modeled object in a planar image from a perspective when the to-be-modeled object (or a three-dimensional model of the to-be-modeled object) is observed from the perspective. FIG. 3 is a front view of a to-be-modeled object according to one or more aspects described herein. As shown in FIG. 3, in a front view (a planar image) of a short sleeve shirt (a to-be-modeled object), a boundary (a contour) of the short sleeve shirt may be jointly formed by a visual boundary and an actual boundary. A solid part is the visual boundary, and a dashed part is the actual boundary.

If the to-be-modeled object includes M object elements, M being an integer greater than 1, a planar image set may include a first planar image and a second planar image of each of the M object elements. Boundary information of the to-be-modeled object further may include geometric boundary annotation information corresponding to each object element. The geometric boundary annotation information corresponding to each object element may indicate an actual boundary of the object element in a planar image (i.e., the first planar image of the object element) from a first perspective, and may indicate an actual boundary of the object element in a planar image (i.e., the second planar image of the object element) from a second perspective.

The computer device may perform contour detection on each of the planar images in the planar image set (for example, through image binarization or the Laplace algorithm), to obtain a boundary of the to-be-modeled object (or object element) in each planar image. Further, after obtaining the boundary of the to-be-modeled object (or object element) in each planar image, the computer device may further perform boundary optimization processing on the boundary of the to-be-modeled object (or the object element) in each planar image by using a trajectory compression algorithm (such as the Douglas-Peucker algorithm), to obtain an optimized boundary. The computer device may display the boundary of the to-be-modeled object (or the object element) in each planar image, and generate boundary information of the to-be-modeled object based on a boundary marking operation of a modeler.

The computer device may perform boundary identification processing on each of the planar images in the planar image set by using a boundary identification model, to obtain the boundary information of the to-be-modeled object. The boundary identification processing may identify an actual boundary and a visual boundary of the to-be-modeled object (or the object element) in each planar image. A training process of the boundary identification model may include: performing boundary identification processing on boundary training data by using an initial model, to obtain an identification result corresponding to the boundary training data; and optimizing a relevant parameter of the initial model (for example, adjusting a quantity of network layers or a scale of a convolutional kernel) based on a difference between the identification result corresponding to the boundary training data and calibration data corresponding to the boundary training data, to obtain the boundary identification model. The boundary information of the to-be-modeled object may be determined through the boundary identification model, so that labor costs may be reduced, and modeling efficiency may be further improved.

S203: Perform depth prediction processing on each of planar images in the planar image set, to obtain depth information of the to-be-modeled object.

The depth information of the to-be-modeled object may include depth information of associated pixel points (for example, pixel points for representing the to-be-modeled object in a planar image) of the to-be-modeled object in each planar image. The computer device may perform depth prediction processing on each of the planar images in the planar image set through the depth prediction model, to obtain the depth information of the to-be-modeled object. In an implementation, when the to-be-modeled object includes M object elements, depth information corresponding to each of the M object elements may be obtained.

In an implementation, a training process of the depth prediction model may include: performing, by the depth prediction model, depth prediction processing on a target pixel point associated with a target object in a training image, to obtain a depth prediction result corresponding to the target pixel point; and predicting a normal vector of each target pixel point based on the depth prediction result of each target pixel point. Specifically, at least one candidate normal vector of the target pixel point may be determined based on K (K being an integer greater than 2) adjacent pixel points (pixel points that are spaced part from the target pixel point by a quantity of pixel points less than a threshold) of the target pixel point, and weighted summation may be performed on the at least one candidate normal vector of the target pixel point, to obtain a normal vector of the target pixel point. After the normal vector of each target pixel point is predicted, the depth prediction model may be jointly optimized based on depth difference information and normal vector difference information, to obtain an optimized depth prediction model, the depth difference information being obtained based on a difference between the depth prediction result of each target pixel point and an annotation result corresponding to the training image, and the normal vector difference information being obtained based on a difference between the predicted normal vector of each target pixel point and a true normal vector of the target pixel point. To better enable a neural network (i.e., a depth prediction model) to perceive local geometric context information and restore more details, normal vector information may be calculated by using an adaptive method while predicting the depth information, and at the same time, a depth and a normal vector may be supervised to cause the two geometric constraints to be associated and jointly optimize the depth prediction model, thereby improving accuracy of predicting the depth information by the depth prediction model, and predicting more accurate depth information about the object element of the to-be-modeled object.

In the training process of the depth prediction model, the depth prediction model may be jointly optimized through the depth difference information and the normal vector difference information. Compared with the optimization of the depth prediction model only through the depth difference information, accuracy of the optimized depth prediction model may be improved.

S204: Model the to-be-modeled object based on the boundary information of the to-be-modeled object and the depth information of the to-be-modeled object, to obtain a three-dimensional model of the to-be-modeled object.

The depth information of the to-be-modeled object may include depth information of associated pixel points (for example, pixel points for representing the to-be-modeled object in a planar image) of the to-be-modeled object in each planar image of the planar image set. The computer device may restore a position of the pixel point associated with the to-be-modeled object in a three-dimensional space based on the depth information of the pixel point associated with the to-be-modeled object in each planar image. After the position of the pixel point associated with the to-be-modeled object in the three-dimensional space is obtained, the computer device may perform stitching processing on the pixel points associated with the to-be-modeled object in the three-dimensional space based on the first geometric boundary annotation information and the second geometric boundary annotation information, to obtain a three-dimensional boundary line of the to-be-modeled object. The three-dimensional boundary line of the to-be-modeled object may indicate an actual boundary of the to-be-modeled object in the three-dimensional space.

For example, assuming that an actual boundary of the to-be-modeled object indicated by the first geometric boundary annotation information in the first planar image includes a pixel point 1 to a pixel point 10, and an actual boundary of the to-be-modeled object indicated by the second geometric boundary annotation information in the second planar image includes a pixel point 10 to a pixel point 20, the computer device may perform stitching processing on the pixel point 1 to the pixel point 20 in the three-dimensional space based on the first geometric boundary annotation information and the second geometric boundary annotation information (for example, connecting the pixel point 1 to the pixel point 20 in series in the three-dimensional space), to obtain a three-dimensional boundary line of the to-be-modeled object.

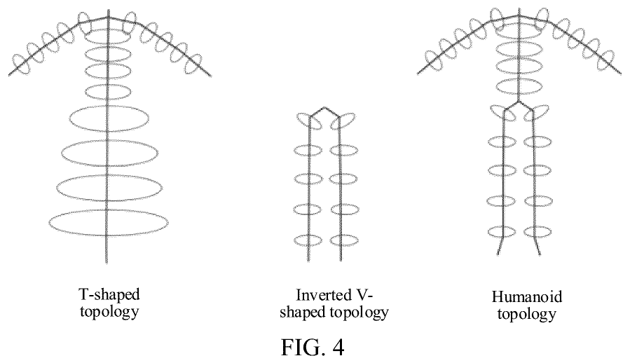

After obtaining the three-dimensional boundary line of the to-be-modeled object, the computer device may generate a three-dimensional model of the to-be-modeled object through the three-dimensional boundary line of the to-be-modeled object. Specifically, the computer device may determine a mesh template corresponding to the to-be-modeled object based on a topology classification of the three-dimensional boundary line of the to-be-modeled object. Different topology classifications correspond to different mesh templates. FIG. 4 is a schematic diagram of a common topology type according to one or more aspects described herein. As shown in FIG. 4, the common topology type may include a T-shaped topology, an inverted V-shaped topology, and a humanoid topology. The T-shaped topology may represent clothing such as a shirt, a suit, an overcoat, and a skirt. The inverted V-shaped topology may represent clothing such as pants. The humanoid topology may represent a jumpsuit, and the like. After a mesh template corresponding to a to-be-modeled object is determined, a computer device may perform cutting processing on the mesh template corresponding to the to-be-modeled object based on a three-dimensional boundary line of the to-be-modeled object (for example, removing a mesh outside the three-dimensional boundary line of the to-be-modeled object in the mesh template), to obtain a three-dimensional model of the to-be-modeled object.

The computer device may further obtain a smoothness constraint condition of the mesh template corresponding to the to-be-modeled object and a restoration degree constraint condition of the to-be-modeled object, predict a mesh deformation parameter corresponding to the to-be-modeled object based on a position of the to-be-modeled object in a three-dimensional space, the smoothness constraint condition of the mesh template corresponding to the to-be-modeled object, and the restoration degree constraint condition of the to-be-modeled object, and perform model optimization processing on the three-dimensional model of the to-be-modeled object based on the mesh deformation parameter corresponding to the to-be-modeled object, to obtain a three-dimensional model after the model optimization processing. The model optimization processing may be performed on the three-dimensional model of the to-be-modeled object based on the position of the to-be-modeled object in the three-dimensional space, the smoothness constraint condition of the mesh template corresponding to the to-be-modeled object, and the restoration degree constraint condition of the to-be-modeled object, which may enhance a restoration degree of details (such as wrinkles of clothing) of the three-dimensional model, and further improve quality of the three-dimensional model of the to-be-modeled object.

The smoothness constraint condition and the restoration degree constraint condition may perform geometric deformation on the three-dimensional model, to obtain a mesh deformation parameter. A three-dimensional model of the to-be-modeled object having detail features may be obtained through optimization based on the mesh deformation parameter. Specifically, a three-dimensional model corresponding to a piece of clothing such as a shirt, a suit, an overcoat, or a skirt obtained by performing cutting processing on the mesh template may be deformed, to obtain a clothing shape having some restored details. An optimization problem may be solved by using the depth information predicted by the depth prediction processing as a reference, and considering smoothness and a geometric restoration degree of the model as constraints, to obtain a better mesh deformation parameter. After the deformation of the three-dimensional model of the to-be-modeled object is completed based on the better mesh deformation parameter, a better three-dimensional model may be obtained. In this way, the cut template can keep orderliness and smoothness of wires while being restored to a geometric shape.

Boundary information of the to-be-modeled object may be obtained from planar images of the to-be-modeled object from different perspectives. Stitching processing such as connecting pixel points in series may be performed based on the boundary information to determine a boundary of the to-be-modeled object in the three-dimensional space, to cut a mesh template. Depth prediction processing may be performed on each of planar images in a planar image set, to obtain depth information of the to-be-modeled object. The to-be-modeled object may be modeled through the cut mesh template based on the boundary information of the to-be-modeled object and the depth information of the to-be-modeled object, to obtain a three-dimensional model of the to-be-modeled object, thereby better satisfying automation and intelligent functions of three-dimensional modeling. In addition, a modeling process of the to-be-modeled object may be constrained based on the depth information of the to-be-modeled object and the boundary information of the to-be-modeled object, which may improve quality of the three-dimensional model of the to-be-modeled object. In addition, in the training process of the depth prediction model, the depth prediction model may be jointly optimized through depth difference information and normal vector difference information, which may improve accuracy of the optimized depth prediction model.

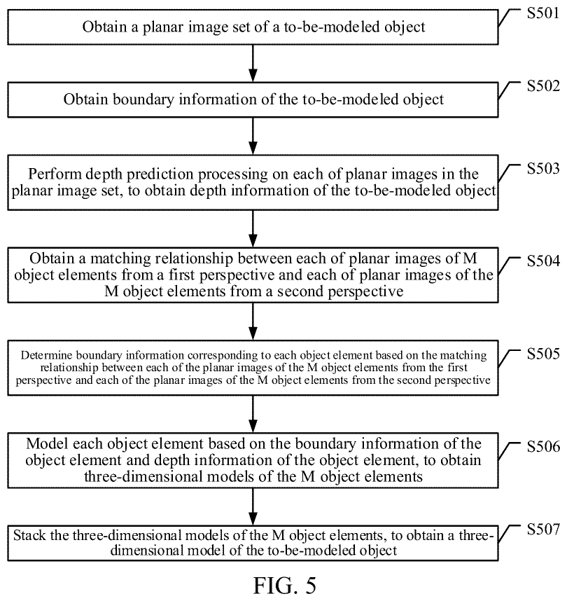

FIG. 5 is a flowchart of another three-dimensional modeling method according to one or more aspects described herein. The three-dimensional modeling method may be performed by a computer device. The computer device may be a terminal device or a server. As shown in FIG. 5, the three-dimensional modeling method may include the following operations S501-S507.

S501: Obtain a planar image set of a to-be-modeled object.

S502: Obtain boundary information of the to-be-modeled object.

S503: Perform depth prediction processing on each of the planar images in the planar image set, to obtain depth information of the to-be-modeled object.

For specific implementations of operation S501 to operation S503, reference may be made to implementations of operation S201 to operation S203 in FIG. 2. Details are not described herein again.

S504: Obtain a matching relationship between a planar image of each of M object elements from a first perspective and a planar image of each of the M object elements from a second perspective.

A first planar image may be any one of a front view and a back view of the to-be-modeled object, and a second planar image may be the other of the front view and the back view of the to-be-modeled object other than the first planar image. The computer device may perform view transformation processing on the planar images (i.e., first planar images) of the M object elements from the first perspective based on the second perspective, to obtain M transformed views.

The computer device may determine a matching relationship between the transformed view and the planar image from the second perspective through a chamfer distance between a sampling point on a visual boundary in the transformed view and a sampling point on a visual boundary in the planar image from the second perspective, and then may determine a matching relationship between the planar image from the first perspective and the planar image from the second perspective. Each visual boundary may include a plurality of (at least two) sampling points. For example, if a chamfer distance between a sampling point on a visual boundary in a transformed view 1 and a sampling point on a visual boundary in a planar image 2 from the second perspective is less than a distance threshold, the computer device may determine that a planar image 1 from the first perspective corresponding to the transformed view 1 matches the planar image 2 from the second perspective.

After obtaining the M transformed views, the computer device may determine the matching relationship between the planar image of each of the M object elements from the first perspective and the planar image of each of the M object elements from the second perspective through a similarity between a boundary of an object element in each transformed view and a boundary of each of the M object elements in the planar image from the second perspective. The similarity between the boundaries may be determined through the chamfer distance between the sampling point on the visual boundary in the transformed view and the sampling point on the visual boundary in the planar image from the second perspective. The similarity may be inversely proportional to the chamfer distance between the sampling points. For example, assuming that M=3, a second transformed view is obtained by performing view transformation processing on a second planar image from the first perspective, a similarity between a boundary of the object element in the second transformed view and a boundary of an object element in a first planar image from the second perspective being 95%, a similarity between the boundary of the object element in the second transformed view and a boundary of an object element in a second planar image from the second perspective being 25%, a similarity between the boundary of the object element in the second transformed view and a boundary of an object element in a third planar image from the second perspective being 13%, and then the computer device may determine that the second planar image from the first perspective matches the first planar image from the second perspective (the two planar images belonging to planar images of the same object element).

A layer identifier may be associated with each planar image in the planar image set. The computer device may determine the matching relationship between the planar image of each of the M object elements from the first perspective and the planar image of each of the M object elements from the second perspective based on the layer identifier associated with each planar image. For example, if a layer identifier associated with the planar image 1 from the first perspective is the same as a layer identifier associated with a planar image 3 from the second perspective, it may be determined that the planar image 1 from the first perspective matches the planar image 3 from the second perspective (the two planar images belonging to planar images of the same object element).

S505: Determine boundary information corresponding to each object element based on the matching relationship between the planar image of each of the M object elements from the first perspective and the planar image of each of the M object elements from the second perspective. For any one of the M object elements, a first planar image and a second planar image of the any one object element may be obtained based on the matching relationship.

The computer device may obtain, through geometric boundary annotation information of a target object element in the M object elements in the first planar image and geometric boundary annotation information of the target object element in the second planar image, complete boundary information corresponding to the target object element. The target object element may be any one of the M object elements.

S506: Model each object element based on the boundary information of the object element and the depth information of the object element, to obtain three-dimensional models of each of the M object elements.

Depth information of the target object element may include depth information of associated pixel points (such as pixel points for representing target object elements in the first planar image and the second planar image) in the first planar image and the second planar image corresponding to the target object element in the planar image set. The computer device may restore a position of the pixel point associated with the target object element in a three-dimensional space based on the depth information of the pixel points associated with the target object element in the first planar image and the second planar image. After obtaining the position of the pixel point associated with the target object element in the three-dimensional space, the computer device may perform stitching processing on the pixel points associated with the target object element in the three-dimensional space based on the geometric boundary annotation information in the first planar image and the geometric boundary annotation information in the second planar image, to obtain a three-dimensional boundary line of the target object element. The three-dimensional boundary line of the target object element may indicate an actual boundary of the target object element in the three-dimensional space.

After obtaining the three-dimensional boundary line of the target object element, the computer device may generate a three-dimensional model of the target object element through the three-dimensional boundary line of the target object element. Specifically, the computer device may determine a mesh template corresponding to the target object element based on a topology classification of the three-dimensional boundary line of the target object element. Different topology classifications correspond to different mesh templates. After the mesh template corresponding to the target object element is determined, the computer device may perform cutting processing on the mesh template corresponding to the target object element based on the three-dimensional boundary line of the target object element (for example, removing a mesh outside the three-dimensional boundary line of the target object element in the mesh template), to obtain the three-dimensional model of the target object element.

The computer device may further obtain a smoothness constraint condition of the mesh template corresponding to the target object element and a restoration degree constraint condition of the target object element, predict a mesh deformation parameter corresponding to the target object element based on a position of the target object element in a three-dimensional space, the smoothness constraint condition of the mesh template corresponding to the target object element, and the restoration degree constraint condition of the target object element, and perform model optimization processing on the three-dimensional model of the target object element based on the mesh deformation parameter corresponding to the target object element, to obtain the three-dimensional model after the model optimization processing. The model optimization processing may be performed on the three-dimensional model of the target object element based on the position of the target object element in the three-dimensional space, the smoothness constraint condition of the mesh template corresponding to the target object element, and the restoration degree constraint condition of the target object element, which may enhance a restoration degree of details (such as wrinkles of clothing) of the three- dimensional model, and further improve quality of the three-dimensional model of the target object element.

Based on the foregoing implementations, the computer device may obtain three-dimensional models of M object elements included in the to-be-modeled object.

S507: Stack the three-dimensional models of the M object elements, to obtain a three-dimensional model of the to-be-modeled object.

Each object element may be associated with a layer identifier, the layer identifier indicating a display priority of an associated object element. If three-dimensional models of at least two object elements have an overlapping region, the computer device may determine display priorities of the three-dimensional models of the at least two object elements based on the layer identifiers associated with the at least two object elements, and displays, in the overlapping region, a three-dimensional model of an object element of the at least two object elements of which the three-dimensional model has a highest display priority. For example, it is assumed that a value of a layer identifier is directly proportional to a display priority of a three-dimensional model of an object element (i.e., a larger value of a layer identifier associated with an object element indicates a higher display priority of a three-dimensional model of the object element). If a three-dimensional model of an object element 1 and a three-dimensional model of an object element 2 have an overlapping region A, a value of a layer identifier associated with the object element 1 is 3, and a value of a layer identifier associated with the object element 2 is 7, the computer device may display the three-dimensional model of the object element 2 in the overlapping region A.

If it is detected that three-dimensional models of at least two object elements existing in the three-dimensional model of the to-be-modeled object are interlaced with each other, the computer device may perform mesh optimization processing on a mesh included in the three-dimensional model of at least one of the at least two object elements based on the layer identifiers associated with the at least two object elements (for example, adjusting a position of part of the mesh in the three-dimensional model of the object element in the three-dimensional space), to obtain a three-dimensional model of the to-be-modeled object after the mesh optimization processing. Three-dimensional models of any two object elements in the three-dimensional model of the to-be-modeled object after the mesh optimization processing are not interlaced with each other. Three-dimensional models of two object elements being interlaced with each other may be understood to mean that at least one face of a three-dimensional model of an object element 1 is interlaced with at least one face of a three-dimensional model of an object element 2.

The three-dimensional model of the to-be-modeled object may be optimized based on the layer identifier associated with the object element, which may further improve quality of the three-dimensional model of the to-be-modeled object.

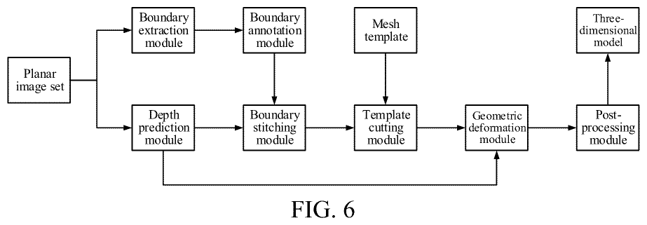

FIG. 6 is a frame diagram of a three-dimensional modeling process according to one or more aspects described herein. As shown in FIG. 6, the three-dimensional modeling method provided herein may be cooperatively implemented by a boundary extraction (Polygon) module, a boundary annotation module, a depth prediction module, a boundary stitching module, a template cutting (Base Cut) module, a geometric deformation (Wrap) module, and a post-processing module. Specifically:
(1) The boundary extraction (Polygon) module may perform boundary detection on each planar image in a planar image set, to obtain a boundary of an object element in the planar image. The boundary of the object element may further be simplified through a trajectory compression algorithm (such as the Douglas-Peucker algorithm), to obtain a simplified boundary of the object element.
(2) The boundary annotation module may further annotate boundaries of the object element, to indicate an actual boundary and a visual boundary in the boundaries of the object element. The actual boundary in each planar image may be determined based on a marking operation performed by a modeler on the boundary of the object element. The actual boundary in each planar image may be obtained by identifying the boundary of the object element through a boundary identification model.
(3) The depth prediction module may perform depth prediction processing on the planar image in the planar image set, to obtain depth information of each pixel point in the planar image. The depth prediction module may perform depth prediction processing on the planar image in the planar image set through a depth prediction model, to obtain the depth information of each pixel point in the planar image. To improve accuracy of the depth prediction model, during training of the depth prediction model, the depth prediction model may be jointly optimized by supervising a depth of a pixel point and a normal vector of the pixel point.
(4) The boundary stitching module may determine a three-dimensional boundary line of each object element. Specifically, the boundary stitching module may determine a matching relationship between each planar image and the object element in the planar image set based on boundary annotation information of the object element in a planar image transmitted by the boundary annotation module. Then the three-dimensional boundary line of each object element may be determined through boundary annotation information in the planar image (a first planar image and a second planar image) corresponding to each object element and the depth information of each pixel point transmitted by the depth prediction module. For a specific implementation, reference may be made to an implementation of operation S506 in FIG. 5. Details are not described herein again.
(5) The template cutting (Base Cut) module may obtain a mesh model of the object element based on the three-dimensional boundary line of the object element transmitted by the boundary stitching module. Specifically, a corresponding topology type may be first determined based on the three-dimensional boundary line of the object element, a corresponding mesh template may be determined based on the topology type, and then the corresponding mesh template may be cut based on the three-dimensional boundary line of the object element, to obtain the mesh model of the object element.
(6) The geometric deformation (Wrap) module may restore details (such as wrinkles of clothing) of the object element, to improve quality of the three-dimensional model of the to-be-modeled object. The geometric deformation module may perform constraint solving on a mesh deformation parameter based on the depth information of each pixel point transmitted by the depth prediction module, mesh smoothness, and a restoration degree, to obtain a mesh deformation parameter corresponding to the mesh model of the object element, and may perform mesh optimization on the mesh model of the object element based on the mesh deformation parameter, to obtain a mesh model of the object element after the mesh optimization.
(7) The post-processing module may combine the mesh models of the object elements, to obtain a three-dimensional model of the to-be-modeled object. If it is detected that mesh models that are interlaced with each other exist during combination of the mesh models, the mesh in the model may be adjusted based on the layer identifier corresponding to each object element, so that no mesh models interlaced with each other exist in the adjusted three-dimensional model of the to-be-modeled object.

The three-dimensional modeling method may be applied to related fields involving planar image modeling such as rapid modeling of game character clothing. An example in which rapid modeling of game character clothing is used. A planar image of clothing designed by a game developer may be rapidly modeled through the three-dimensional modeling method, to obtain a high-quality three-dimensional clothing model, thereby improving game development efficiency.

The three-dimensional modeling scheme may be integrated into three-dimensional modeling software in the form of a plug-in. A modeler may invoke the plug-in integrated with the three-dimensional modeling scheme provided herein to perform three-dimensional modeling on a planar image set of a to-be-modeled object, to obtain a three-dimensional model of the to-be-modeled object. A specific process is as follows. The three-dimensional modeling software may load the planar image set, and a layer list and layer state information may be obtained after the loading is complete. The modeler may select a target layer to open an editing interface of the target layer. The target layer editing interface may include a “boundary extraction” button, and the modeler may automatically extract a boundary of an object element in the target layer by triggering the “boundary extraction” button. The extracted boundary may be marked on a planar image in the target layer by using a line segment with a preset color. The modeler may mark boundaries of the object element in the target layer to indicate an actual boundary in the boundaries of the object element. The three-dimensional modeling software may perform modeling based on the loaded planar image set and the actual boundary in the boundaries of the object element indicated by the modeler, to obtain a modeling result. In a modeling process, the modeler may choose to model one or more object elements. If a plurality of object elements are modeled, an obtained modeling result may be an overall three-dimensional model including three-dimensional models of the plurality of object elements.

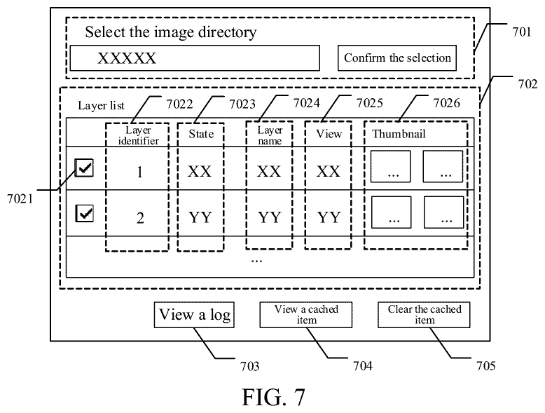

FIG. 7 is a schematic diagram of a management page of a three-dimensional modeling plug-in according to one or more aspects described herein. As shown in FIG. 7, a management page of a three-dimensional modeling plug-in may include a path selection entry 701, a layer list display region 702, a modeling record viewing entry 703, a modeling result viewing entry 704, and a modeling result clearing control 705. The path selection entry 701 may select a path of a planar image that needs to be imported. The layer list display region 702 may display a layer list. The layer list may include at least one of the following: a layer selection box 7021 (for selecting a layer, or canceling a selected layer), a layer identifier 7022 (for indicating a layer sequence, and comprising a trigger for entering an editing page of a corresponding layer), a state display bar 7023 (for displaying a modeling state of the layer), a layer name 7024, a view 7025 (for indicating an observation perspective corresponding to a planar image in a layer), and a thumbnail 7026 (for displaying a thumbnail of object elements in a layer). The modeling record viewing entry 703 may be used to view a modeling record. The modeling result viewing entry 704 may be used to view a completed modeling result. The modeling result clearing control 705 may clear the completed modeling result.

Based on the one or more aspects of of FIG. 2, the model optimization processing may be performed on the three-dimensional model of the to-be-modeled object based on the position of the to-be-modeled object in the three-dimensional space, the smoothness constraint condition of the mesh template corresponding to the to-be-modeled object, and the restoration degree constraint condition of the to-be-modeled object, which may enhance a restoration degree of details (such as wrinkles of clothing) of the three-dimensional model, and further improve quality of the three-dimensional model of the to-be-modeled object. The three-dimensional model of the to-be-modeled object may be optimized based on the layer identifier associated with the object element, which may further improve quality of the three-dimensional model of the to-be-modeled object. In addition, the three-dimensional modeling scheme may be integrated into three-dimensional modeling software in the form of a plug-in, which may simplify an image modeling process and improve efficiency of three-dimensional model modeling.

An apparatus for three-dimensional modeling is provided below.

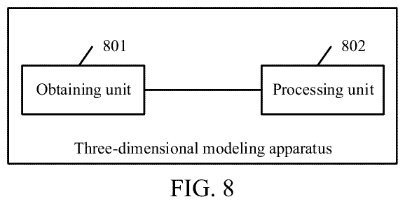

FIG. 8 is a schematic structural diagram of a three-dimensional modeling apparatus according to one or more aspects described herein. The three-dimensional modeling apparatus shown in FIG. 8 may be installed in a computer device. The computer device may specifically be a terminal device or a server. The three-dimensional modeling apparatus shown in FIG. 8 may be configured to perform some or all of the functions in the method described in the drawings above. Referring to FIG. 8, the three-dimensional modeling apparatus may include:
an obtaining unit 801 that may obtain:
a planar image set of a to-be-modeled object, the planar image set including a first planar image and a second planar image, the first planar image and the second planar image being planar images of the to-be-modeled object from different perspectives; and
boundary information of the to-be-modeled object, the boundary information including first geometric boundary annotation information and second geometric boundary annotation information, the first geometric boundary annotation information indicating an actual boundary of the to-be-modeled object in the first planar image, and the second geometric boundary annotation information indicating an actual boundary of the to-be-modeled object in the second planar image; and
a processing unit 802 that may:
perform depth prediction processing on each of the planar images in the planar image set, to obtain depth information of the to-be-modeled object; and
model the to-be-modeled object based on the boundary information of the to-be-modeled object and the depth information of the to-be-modeled object, to obtain a three-dimensional model of the to-be-modeled object.

The depth information of the to-be-modeled object may include depth information of a pixel point associated with the to-be-modeled object in each planar image of the planar image set. The processing unit 802 may model the to-be-modeled object based on the boundary information of the to-be-modeled object and the depth information of the to-be-modeled object, to obtain a three-dimensional model of the to-be-modeled object, and may further:
restore a position of the pixel point associated with the to-be-modeled object in a three-dimensional space based on the depth information of the pixel point associated with the to-be-modeled object in each planar image;
perform stitching processing on the actual boundaries of the to-be-modeled object indicated by the first geometric boundary annotation information and the second geometric boundary annotation information, to obtain a three-dimensional boundary line of the to-be-modeled object; and
generate the three-dimensional model of the to-be-modeled object through the three-dimensional boundary line of the to-be-modeled object.

The processing unit 802 may generate the three-dimensional model of the to-be-modeled object through the three-dimensional boundary line of the to-be-modeled object, and may further:
determine a mesh template corresponding to the to-be-modeled object based on topology classification of the three-dimensional boundary line of the to-be-modeled object; and
cut the mesh template corresponding to the to-be-modeled object based on the three-dimensional boundary line of the to-be-modeled object, to obtain the three-dimensional model of the to-be-modeled object.

The processing unit 802 may further:
obtain a smoothness constraint condition of the mesh template corresponding to the to-be-modeled object and a restoration degree constraint condition of the to-be-modeled object;
predict a mesh deformation parameter corresponding to the to-be-modeled object based on a position of the to-be-modeled object in the three-dimensional space, the smoothness constraint condition of the mesh template corresponding to the to-be-modeled object, and the restoration degree constraint condition of the to-be-modeled object; and
perform model optimization processing on the three-dimensional model of the to-be-modeled object based on the mesh deformation parameter corresponding to the to-be-modeled object, to obtain a three-dimensional model after the model optimization processing.

The to-be-modeled object may include M object elements, and the planar image set may include a planar image of each object element from a first perspective and a planar image of each object element from a second perspective, M being an integer greater than 1; the boundary information of the to-be-modeled object may include geometric boundary annotation information corresponding to each object element, the geometric boundary annotation information corresponding to each object element being configured for indicating an actual boundary of the object element in the planar image from the first perspective and an actual boundary of the object element in the planar image from the second perspective; and the depth information of the to-be-modeled object may include depth information of the M object elements.

The processing unit 802 may model the to-be-modeled object based on the boundary information of the to-be-modeled object and the depth information of the to-be-modeled object, to obtain a three-dimensional model of the to-be-modeled object, and may further:
obtain a matching relationship between a planar image of each of the M object elements from the first perspective and a planar image of each of the M object elements from the second perspective;
determine boundary information corresponding to each object element based on the matching relationship between the planar image of each of the M object elements from the first perspective and the planar image of each of the M object elements from the second perspective;
model each object element based on the boundary information of the object element and the depth information of the object element, to obtain three-dimensional models of the M object elements; and
stack the three-dimensional models of the M object elements, to obtain the three-dimensional model of the to-be-modeled object.

The first planar image may be any one of a front view and a back view of the to-be-modeled object, and the second planar image may be the other of the front view and the back view of the to-be-modeled object other than the first planar image. The processing unit 802 may obtain a matching relationship between a planar image of each of the M object elements from the first perspective and a planar image of each of the M object elements from the second perspective;
perform view transformation processing on the planar images of the M object elements from the first perspective based on the second perspective, to obtain M transformed views; and
determine a matching relationship between the planar image of each of the M object elements from the first perspective and the planar image of each of the M object elements from the second perspective based on a similarity between a boundary of an object element in each transformed view and a boundary of each of the M object elements in the planar image from the second perspective.

Each object element may be associated with a layer identifier that may indicate a display priority of an associated object element. The processing unit 802 may further:
determine, if three-dimensional models of at least two object elements have an overlapping region, a display priority of each of the three-dimensional models of the at least two object elements through the layer identifiers associated with the at least two object elements; and
display, in the overlapping region, a three-dimensional model of an object element of the at least two object elements of which the three-dimensional model has a highest display priority.

Each object element may be associated with a layer identifier, that may indicate a display priority of an associated object element. If it is detected that three-dimensional models of at least two object elements existing in the three-dimensional model of the to-be-modeled object are interlaced with each other, the processing unit 802 may:
perform mesh optimization processing on a mesh included in the three-dimensional model of at least one of the at least two object elements based on the layer identifiers associated with the at least two object elements, to obtain a three-dimensional model of the to-be-modeled object after the mesh optimization processing,
three-dimensional models of any two object elements in the three-dimensional model of the to-be-modeled object after the mesh optimization processing being not interlaced with each other.

The depth information of the to-be-modeled object may be obtained by performing the depth prediction processing on each of the planar images in the planar image set by using a depth prediction model, and a training process of the depth prediction model that may include:
performing, by the depth prediction model, depth prediction processing on a target pixel point associated with a target object in a training image, to obtain a depth prediction result corresponding to the target pixel point;
predicting a normal vector of each target pixel point based on the depth prediction result of each target pixel point; and
jointly optimizing the depth prediction model based on depth difference information and normal vector difference information, to obtain an optimized depth prediction model,
the depth difference information being obtained based on a difference between the depth prediction result of each target pixel point and an annotation result corresponding to the training image, and the normal vector difference information being obtained based on a difference between the predicted normal vector of each target pixel point and a true normal vector of the target pixel point.

The processing unit 802 may obtain boundary information of a to-be-modeled object, and may:
perform boundary detection on each of the planar images in the planar image set of the to-be-modeled object, to obtain a boundary of the to-be-modeled object in each planar image; and
perform identification processing on a boundary of the to-be-modeled object in each planar image by using a geometric boundary identification model, to obtain geometric boundary annotation information corresponding to each planar image.

According to one or more aspects described herein, some operations involved in the three-dimensional modeling method shown in FIG. 2 and FIG. 5 may be performed by the units in the three-dimensional modeling apparatus shown in FIG. 8. For example, operation S201 and operation S202 shown in FIG. 2 may be performed by the obtaining unit 801 shown in FIG. 8, and operation S203 and operation S204 may be performed by the processing unit 802 shown in FIG. 8. Operation S501, operation S502, and operation S504 shown in FIG. 5 may be performed by the obtaining unit 801 shown in FIG. 8, and operation S503 and operation S505 to operation S507 may be performed by the processing unit 802 shown in FIG. 8. The units in the three-dimensional modeling apparatus shown in FIG. 8 may be separately or all combined into one or several additional units, or one (some) of the units may further be split into a plurality of units with smaller functions, so as to realize the same operation without affecting the implementation of the technical effects. The foregoing units are divided based on logical functions. Functions of one unit may also be implemented by a plurality of units, or the functions of the plurality of units may be implemented by one unit. The three-dimensional modeling apparatus may also include another unit. These functions may also be implemented with assistance of another unit, and may be implemented by a plurality of units in collaboration.

A computer program (including program code) that can perform the operations involved in the corresponding methods shown in FIG. 2 and FIG. 5 may be run on a general-purpose computing apparatus such as a computer device including processing elements such as a central processing unit (CPU) and storage elements such as a random access storage medium (RAM) and a read-only storage medium (ROM), to construct the three-dimensional modeling apparatus shown in FIG. 8 and implement the three-dimensional modeling method described herein. The computer program may be stored in, for example, a non-transitory computer-readable recording medium, and may be loaded into the computing apparatus through a computer-readable recording medium and executed in the computing apparatus.

The principles and the beneficial effects of the three-dimensional modeling apparatus described herein in solving the problems are similar to the principles and the beneficial effects of the three-dimensional modeling method. Reference may be made to the principles and the beneficial effects of the implementation of the method. For brevity, details are not described herein again.

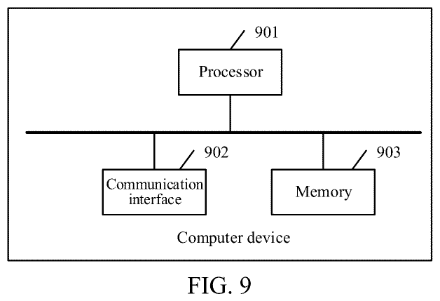

FIG. 9 is a schematic structural diagram of a computer device according to one or more aspects described herein. The computer device may be a terminal device or a server. As shown in FIG. 9, the computer device may include at least a processor 901, a communication interface 902, and a memory 903. The processor 901, the communication interface 902, and the memory 903 may be connected through a bus or in another manner. The processor 901 (or referred to as a CPU) may be a computing core and a control core of the computer device, which may parse various instructions in the computer device and process various data of the computer device. For example, the CPU may be configured to parse an on/off instruction transmitted by an object to the computer device, and control the computer device to perform an on/off operation. For another example, the CPU may transfer various types of interactive data between internal structures of the computer device. The communication interface 902 may include a standard wired interface and a standard wireless interface (such as a Wi-Fi interface and a mobile communication interface), and may be controlled by the processor 901 to transmit and receive data. The communication interface 902 may further be configured for data transmission and interaction within the computer device. The memory 903 may be a memory device in the computer device, which may store a program and data. The memory 903 herein may include a built-in memory of the computer device, and certainly, may also include an extended memory supported by the computer device. The memory 903 may provide a storage space. The storage space may store an operating system of the computer device. The operating system may include but is not limited to an Android system, an iOS system, a Windows Phone system, and the like, which is not limited n.

One or more aspects described herein further provide a non-transitory computer-readable storage medium (memory). The non-transitory computer-readable storage medium may be a memory device in a computer device, which may store a program and data. The non-transitory computer-readable storage medium herein may include a built-in storage medium in the computer device, and may also include an extended storage medium supported by the computer device. The non-transitory computer-readable storage medium provides a storage space. The storage space stores a processing system of the computer device. In addition, a computer program adapted to be loaded and executed by the processor 901 is further stored in the storage space. The non-transitory computer-readable storage medium herein may be a high-speed RAM memory, or may be a non-volatile memory, for example, at least one magnetic disk memory. The non-transitory computer-readable storage medium may further be at least one non-transitory computer-readable storage medium away from the foregoing processor.

The processor 901 may perform the following operations by running the computer program in the memory 903:
obtaining a planar image set of a to-be-modeled object, the planar image set including a first planar image and a second planar image, the first planar image and the second planar image being planar images of the to-be-modeled object from different perspectives;
obtaining boundary information of the to-be-modeled object, the boundary information including first geometric boundary annotation information and second geometric boundary annotation information, the first geometric boundary annotation information being configured for indicating an actual boundary of the to-be-modeled object in the first planar image, and the second geometric boundary annotation information being configured for indicating an actual boundary of the to-be-modeled object in the second planar image;
performing depth prediction processing on each of the planar images in the planar image set, to obtain depth information of the to-be-modeled object; and
modeling the to-be-modeled object based on the boundary information of the to-be-modeled object and the depth information of the to-be-modeled object, to obtain a three-dimensional model of the to-be-modeled object.

The depth information of the to-be-modeled object may include depth information of a pixel point associated with the to-be-modeled object in each planar image of the planar image set. Modeling, by the processor 901, the to-be-modeled object based on the boundary information of the to-be-modeled object and the depth information of the to-be-modeled object, to obtain the three-dimensional model of the to-be-modeled object may include:
restoring a position of the pixel point associated with the to-be-modeled object in a three-dimensional space based on the depth information of the pixel point associated with the to-be-modeled object in each planar image;
performing stitching processing on the actual boundaries of the to-be-modeled object indicated by the first geometric boundary annotation information and the second geometric boundary annotation information, to obtain a three-dimensional boundary line of the to-be-modeled object; and
generating the three-dimensional model of the to-be-modeled object through the three-dimensional boundary line of the to-be-modeled object.

Generating, by the processor 901, the three-dimensional model of the to-be-modeled object through the three-dimensional boundary line of the to-be-modeled object may include:
determining a mesh template corresponding to the to-be-modeled object based on topology classification of the three-dimensional boundary line of the to-be-modeled object; and
cutting the mesh template corresponding to the to-be-modeled object based on the three-dimensional boundary line of the to-be-modeled object, to obtain the three-dimensional model of the to-be-modeled object.

The processor 901 further may perform the following operations by running the computer program in the memory 903:
obtaining a smoothness constraint condition of the mesh template corresponding to the to-be-modeled object and a restoration degree constraint condition of the to-be-modeled object;
predicting a mesh deformation parameter corresponding to the to-be-modeled object based on a position of the to-be-modeled object in the three-dimensional space, the smoothness constraint condition of the mesh template corresponding to the to-be-modeled object, and the restoration degree constraint condition of the to-be-modeled object; and
performing model optimization processing on the three-dimensional model of the to-be-modeled object based on the mesh deformation parameter corresponding to the to-be-modeled object, to obtain a three-dimensional model after the model optimization processing.

The to-be-modeled object may include M object elements, and the planar image set may include a planar image of each object element from a first perspective and a planar image of each object element from a second perspective, M being an integer greater than 1; the boundary information of the to-be-modeled object may include geometric boundary annotation information corresponding to each object element, the geometric boundary annotation information corresponding to each object element being configured for indicating an actual boundary of the object element in the planar image from the first perspective and an actual boundary of the object element in the planar image from the second perspective; and the depth information of the to-be-modeled object may include depth information of the M object elements.

Modeling, by the processor 901, the to-be-modeled object based on the boundary information of the to-be-modeled object and the depth information of the to-be-modeled object, to obtain the three-dimensional model of the to-be-modeled object may include:
obtaining a matching relationship between a planar image of each of the M object elements from the first perspective and a planar image of each of the M object elements from the second perspective;
determining boundary information corresponding to each object element based on the matching relationship between the planar image of each of the M object elements from the first perspective and the planar image of each of the M object elements from the second perspective;
modeling each object element based on the boundary information of the object element and the depth information of the object element, to obtain three-dimensional models of the M object elements; and
stacking the three-dimensional models of the M object elements, to obtain the three-dimensional model of the to-be-modeled object.

A first planar image may be any one of a front view and a back view of the to-be-modeled object, and a second planar image may be the other of the front view and the back view of the to-be-modeled object other than the first planar image. Obtaining, by the processor 901, a matching relationship between a planar image of each of the M object elements from the first perspective and a planar image of each of the M object elements from the second perspective may include:
performing view transformation processing on the planar images of the M object elements from the first perspective based on the second perspective, to obtain M transformed views; and
determining a matching relationship between the planar image of each of the M object elements from the first perspective and the planar image of each of the M object elements from the second perspective based on a similarity between a boundary of an object element in each transformed view and a boundary of each of the M object elements in the planar image from the second perspective.

Each object element may be associated with a layer identifier that may indicate a display priority of an associated object element. The processor 901 further may perform the following operations by running the computer program in the memory 903:
determining, if three-dimensional models of at least two object elements have an overlapping region, a display priority of each of the three-dimensional models of the at least two object elements through the layer identifiers associated with the at least two object elements; and
displaying, in the overlapping region, a three-dimensional model of an object element of the at least two object elements of which the three-dimensional model has a highest display priority.

Each object element may be associated with a layer identifier that may indicate a display priority of an associated object element. If it is detected that three-dimensional models of at least two object elements exist in the three-dimensional model of the to-be-modeled object and are interlaced with each other, the processor 901 further may perform the following operation by running the computer program in the memory 903:
performing mesh optimization processing on a mesh included in the three-dimensional model of at least one of the at least two object elements based on the layer identifiers associated with the at least two object elements, to obtain a three-dimensional model of the to-be-modeled object after the mesh optimization processing,
three-dimensional models of any two object elements in the three-dimensional model of the to-be-modeled object after the mesh optimization processing being not interlaced with each other.

The depth information of the to-be-modeled object may be obtained by performing the depth prediction processing on each of the planar images in the planar image set by using a depth prediction model, and a training process of the depth prediction model may include:
performing, by the depth prediction model, depth prediction processing on a target pixel point associated with a target object in a training image, to obtain a depth prediction result corresponding to the target pixel point;
predicting a normal vector of each target pixel point based on the depth prediction result of each target pixel point; and
jointly optimizing the depth prediction model based on depth difference information and normal vector difference information, to obtain an optimized depth prediction model,
the depth difference information being obtained based on a difference between the depth prediction result of each target pixel point and an annotation result corresponding to the training image, and the normal vector difference information being obtained based on a difference between the predicted normal vector of each target pixel point and a true normal vector of the target pixel point.

Obtaining, by the processor 901, the boundary information of the to-be-modeled object may include:
performing boundary detection on each of the planar images in the planar image set of the to-be-modeled object, to obtain a boundary of the to-be-modeled object in each planar image; and
performing identification processing on a boundary of the to-be-modeled object in each planar image by using a geometric boundary identification model, to obtain geometric boundary annotation information corresponding to each planar image.

The principles and the beneficial effects of the computer device in solving the problems are similar to the principles and the beneficial effects of the three-dimensional modeling method described herein. Reference may be made to the principles and the beneficial effects of the implementation of the method. For brevity, details are not described herein again.

One or more aspects described herein further provide a non-transitory computer-readable storage medium. The non-transitory computer-readable storage medium has a computer program stored therein. The computer program is adapted to be loaded and executed by a processor to implement the three-dimensional modeling method.

One or more aspects described herein further provide a computer program product or a computer program, the computer program product or the computer program including a computer instruction, the computer instruction being stored in a non-transitory computer-readable storage medium. A processor of a computer device reads the computer instruction from the non-transitory computer-readable storage medium, and executes the computer instruction, so that the computer device may perform the foregoing three-dimensional modeling method.

The operations in the method may be adjusted, merged, and deleted in sequence based on an actual need.

The modules in the apparatus may be merged, divided, and deleted based on an actual need.

A person skilled in the art may understand that all or some of the operations of the various methods may be completed by instructing related hardware through a program. The program may be stored in a computer-readable storage medium, and the computer-readable storage medium may include: a flash drive, a ROM, a RAM, a magnetic disk, an optical disc, and the like.

The foregoing content disclosed above is not intended to limit the scope of the claims provided herein. A person of ordinary skill in the art may understand all or part of the processes for implementing the foregoing description, and equivalent changes made according to the claims still fall within the scope covered by the one or more aspects described herein.

What is claimed is:

1. A three-dimensional modeling method, comprising:
obtaining a planar image set of a to-be-modeled object, the planar image set comprising a first planar image of a first object element of the to-be-modeled object from a first perspective and a second planar image of the first object element of the to-be-modeled object from a second perspective that is different from the first perspective;
obtaining boundary information of the to-be-modeled object, the boundary information comprising first boundary information of the first object element, the first boundary information comprising first geometric boundary annotation information and second geometric boundary annotation information, the first geometric boundary annotation information indicating a first actual boundary of the first object element of the to-be-modeled object in the first planar image, and the second geometric boundary annotation information indicating a second actual boundary of the first object element of the to-be-modeled object in the second planar image;
performing depth prediction processing on the first planar image and the second planar image, to obtain depth information of the to-be-modeled object, the depth information comprising first depth information of the first object element; and
modeling the to-be-modeled object based on the boundary information of the to-be-modeled object and the depth information of the to-be-modeled object, to generate a three-dimensional model of the to-be-modeled object.

2. The three-dimensional modeling method according to claim 1, wherein:
the first depth information comprises depth information of a pixel point associated with the first object element in each planar image of the planar image set,
the modeling comprises:
restoring a position of the pixel point associated with the to-be-modeled object in a three-dimensional space based on the depth information of the pixel point associated with the to-be-modeled object in each planar image; and
performing stitching processing on the first actual boundary and the second actual boundary, to obtain a three-dimensional boundary line of the to-be-modeled object, and
the stitching processing comprising:
connecting the pixel points in the three-dimensional space corresponding to the first actual boundary and the second actual boundary of the first object element of the to-be-modeled object indicated by the first geometric boundary annotation information and the second geometric boundary annotation information in series; and
generating the three-dimensional model of the to-be-modeled object through the three-dimensional boundary line of the to-be-modeled object.

3. The three-dimensional modeling method according to claim 2, wherein the generating the three-dimensional model of the to-be-modeled object through the three-dimensional boundary line of the to-be-modeled object comprises:
determining a mesh template corresponding to the to-be-modeled object based on a topology classification of the three-dimensional boundary line of the to-be-modeled object; and
cutting the mesh template corresponding to the to-be-modeled object based on the three-dimensional boundary line of the to-be-modeled object, to obtain the three-dimensional model of the to-be-modeled object.

4. The three-dimensional modeling method according to claim 3, further comprising:
obtaining a smoothness constraint condition of the mesh template corresponding to the to-be-modeled object and a restoration degree constraint condition of the to-be-modeled object;
predicting a mesh deformation parameter corresponding to the to-be-modeled object based on a position of the to-be-modeled object in the three-dimensional space, the smoothness constraint condition of the mesh template corresponding to the to-be-modeled object, and the restoration degree constraint condition of the to-be-modeled object; and
performing model optimization processing on the three-dimensional model of the to-be-modeled object based on the mesh deformation parameter corresponding to the to-be-modeled object, to obtain a three-dimensional model after the model optimization processing.

5. The three-dimensional modeling method according to claim 1, wherein:
the to-be-modeled object comprises a second object element,
the planar image set comprises a third planar image of the second object element from the first perspective and a fourth planar image of the second object element from the second perspective,
the boundary information of the to-be-modeled object comprises second geometric boundary annotation information corresponding to the second object element, the second geometric boundary annotation information indicating a third actual boundary of the second object element in the third planar image and a fourth actual boundary of the second object element in the fourth planar image,
the depth information of the to-be-modeled object comprises second depth information for the second object element, and
the modeling the to-be-modeled object based on the boundary information of the to-be-modeled object and the depth information of the to-be-modeled object, to obtain a three-dimensional model of the to-be-modeled object comprises:
obtaining a first matching relationship between the first planar image and the second planar image and a second matching relationship between the third planar image and the fourth planar image;
determining first boundary information corresponding to the first object element based on the first matching relationship;
determining second boundary information corresponding to the second object element based on the second matching relationship;
modeling the first object element based on the first boundary information of the first object element and the first depth information of the first object element, to obtain a first three-dimensional model of the first object element;
modeling the second object element based on the second boundary information of the second object element and the second depth information of the second object element, to obtain a second three-dimensional model of the second object element; and
stacking the first three-dimensional model of the first object element and the second three-dimensional model of the second object element, to obtain the three-dimensional model of the to-be-modeled object.

6. The three-dimensional modeling method according to claim 5, wherein the first planar image is a front view of the to-be-modeled object, the second planar image is a back view of the to-be-modeled object, and the obtaining the first matching relationship comprises:
performing view transformation processing on the first and second planar images from the first perspective based on the second perspective, to obtain a first transformed view; and
determining a matching relationship between the first planar image and the second planar image based on a similarity between a boundary of the first object element in the first transformed view and a boundary of the first object element in the second planar image.

7. The three-dimensional modeling method according to claim 5, wherein:
the first object element is associated with a first layer identifier indicating a first display priority of the first object element,
the second object element is associated with a second layer identifier indicating a second display priority of the second object element, and
the method further comprises, in response to a determination the first three-dimensional model and the second three-dimensional model having an overlapping region:
determining, based on the first layer identifier and the second layer identifier, that the first three-dimensional model has a higher display priority than the second three-dimensional model; and
displaying, in the overlapping region, the first three-dimensional model based on its higher display priority.

8. The three-dimensional modeling method according to claim 5, wherein:
the first object element is associated with a first layer identifier indicating a first display priority of the first object element,
the second object element is associated with a second layer identifier indicating a second display priority of the second object element, and,
the method further comprises, based on a determination that the first three-dimensional model and the second three-dimensional model are interlaced with each other:
performing mesh optimization processing on a first mesh in the first three-dimensional model based on the first layer identifier and the second layer identifier, to obtain a three-dimensional model of the to-be-modeled object,
wherein the mesh optimization processing removes interlacing between the first three-dimensional model and the second three-dimensional model.

9. The three-dimensional modeling method according to claim 1, wherein:
the first depth information of the to-be-modeled object is obtained by performing the depth prediction processing on the first planar image and the second planar image by using a depth prediction model, and
a training process of the depth prediction model comprises:
performing, by the depth prediction model, depth prediction processing on a target pixel point associated with a target object in a training image, to obtain a depth prediction result corresponding to the target pixel point;
predicting a normal vector of each target pixel point based on the depth prediction result of each target pixel point; and
jointly optimizing the depth prediction model based on depth difference information and normal vector difference information, to obtain an optimized depth prediction model,
the depth difference information being obtained based on a difference between the depth prediction result of each target pixel point and an annotation result corresponding to the training image, and the normal vector difference information being obtained based on a difference between the normal vector of each target pixel point and a true normal vector of the target pixel point.

10. The three-dimensional modeling method according to claim 1, wherein the first boundary information of the first object element of the to-be-modeled object is obtained by:
performing boundary detection on the first planar image to obtain a first boundary of the first object element in the first planar image;
performing boundary detection on the second planar image to obtain a second boundary of the first object element in the second planar image;
performing identification processing on the first boundary by using a geometric boundary identification model, to obtain first geometric boundary annotation information corresponding to the first planar image; and
performing identification processing on the second boundary by using the geometric boundary identification model, to obtain second geometric boundary annotation information corresponding to the second planar image.

11. A three-dimensional modeling apparatus, comprising:
one or more processors; and
memory storing computer-readable instructions that when executed by the one or more processors, cause the three-dimensional modeling apparatus to:
obtain a planar image set of a first object element of a to-be-modeled object, the planar image set comprising a first planar image of the to-be-modeled object from a first perspective and a second planar image of the to-be-modeled object from a second perspective that is different from the first perspective;
obtain boundary information of the to-be-modeled object, the boundary information comprising first boundary information of the first object element, the first boundary information comprising first geometric boundary annotation information and second geometric boundary annotation information, the first geometric boundary annotation information indicating a first actual boundary of the first object element of the to-be-modeled object in the first planar image, and the second geometric boundary annotation information indicating a second actual boundary of the first object element of the to-be-modeled object in the second planar image;
perform depth prediction processing on the first planar image and the second planar image, to obtain depth information of the to-be-modeled object, the depth information comprising first depth information of the first object element; and
model the to-be-modeled object based on the boundary information of the to-be-modeled object and the depth information of the to-be-modeled object, to generate a three-dimensional model of the to-be-modeled object.

12. The three-dimensional modeling apparatus according to claim 11, wherein:
the first depth information comprises depth information of a pixel point associated with the first object element in each planar image of the planar image set,
the modeling comprises:
restoring a position of the pixel point associated with the to-be-modeled object in a three-dimensional space based on the depth information of the pixel point associated with the to-be-modeled object in each planar image; and
performing stitching processing on the first actual boundary and the second actual boundary, to obtain a three-dimensional boundary line of the to-be-modeled object, and
the stitching processing comprises:
connecting the pixel points in the three-dimensional space corresponding to the first actual boundary and the second actual boundary of the first object element of the to-be-modeled object indicated by the first geometric boundary annotation information and the second geometric boundary annotation information in series; and
generating the three-dimensional model of the to-be-modeled object through the three-dimensional boundary line of the to-be-modeled object.

13. The three-dimensional modeling apparatus according to claim 12, wherein the generating the three-dimensional model of the to-be-modeled object through the three-dimensional boundary line of the to-be-modeled object comprises:
determining a mesh template corresponding to the to-be-modeled object based on a topology classification of the three-dimensional boundary line of the to-be-modeled object; and
cutting the mesh template corresponding to the to-be-modeled object based on the three-dimensional boundary line of the to-be-modeled object, to obtain the three-dimensional model of the to-be-modeled object.

14. The three-dimensional modeling apparatus according to claim 12, the memory storing computer-readable instructions that when executed by the one or more processors, cause the three-dimensional modeling apparatus to:
obtain a smoothness constraint condition of a mesh template corresponding to the to-be-modeled object and a restoration degree constraint condition of the to-be-modeled object;
predict a mesh deformation parameter corresponding to the to-be-modeled object based on a position of the to-be-modeled object in the three-dimensional space, the smoothness constraint condition of the mesh template corresponding to the to-be-modeled object, and the restoration degree constraint condition of the to-be-modeled object; and
perform model optimization processing on the three-dimensional model of the to-be-modeled object based on the mesh deformation parameter corresponding to the to-be-modeled object, to obtain a three-dimensional model after the model optimization processing.

15. The three-dimensional modeling apparatus according to claim 11, wherein:
the to-be-modeled object comprises a second object element,
the planar image set comprises a third planar image of the second object element from the first perspective and a fourth planar image of the second object element from the second perspective,
the boundary information of the to-be-modeled object comprises second geometric boundary annotation information corresponding to the second object element, the second geometric boundary annotation information indicating a third actual boundary of the second object element in the third planar image and a fourth actual boundary of the second object element in the fourth planar image,
the depth information of the to-be-modeled object comprises second depth information for the second object element, and
the modeling the to-be-modeled object based on the boundary information of the to-be-modeled object and the depth information of the to-be-modeled object, to obtain a three-dimensional model of the to-be-modeled object comprises:
obtaining a first matching relationship between the first planar image and the second planar image and a second matching relationship between the third planar image and the fourth planar image;
determining first boundary information corresponding to the first object element based on the first matching relationship;
determining second boundary information corresponding to the second object element based on the second matching relationship;
modeling the first object element based on the first boundary information of the first object element and the first depth information of the first object element, to obtain a first three-dimensional model of the first object element;
modeling the second object element based on the second boundary information of the second object element and the second depth information of the second object element, to obtain a second three-dimensional model of the second object element; and
stacking the first three-dimensional model of the first object element and the second three-dimensional model of the second object element, to obtain the three-dimensional model of the to-be-modeled object.

16. The three-dimensional modeling apparatus according to claim 15, wherein the first planar image is a front view of the to-be-modeled object, the second planar image is a back view of the to-be-modeled object, and the obtaining the first matching relationship comprises:
performing view transformation processing on the first and second planar images from the first perspective based on the second perspective, to obtain a first transformed view; and
determining a matching relationship between the first planar image and the second planar image based on a similarity between a boundary of the first object element in the first transformed view and a boundary of the first object element in the second planar image.

17. The three-dimensional modeling apparatus according to claim 15, wherein:
the first object element is associated with a first layer identifier indicating a first display priority of the first object element,
the second object element is associated with a second layer identifier indicating a second display priority of the second object element, and
the memory storing computer-readable instructions that when executed by the one or more processors, cause the three-dimensional modeling apparatus to, based on a determination the first three-dimensional model and the second three-dimensional model having an overlapping region:
determine, based on the first layer identifier and the second layer identifier, that the first three-dimensional model has a higher display priority than the second three-dimensional model; and
display, in the overlapping region, the first three-dimensional model based on its higher display priority.

18. The three-dimensional modeling apparatus according to claim 15, wherein:
the first object element is associated with a first layer identifier indicating a first display priority of the first object element,
the second object element is associated with a second layer identifier indicating a second display priority of the second object element, and,
the memory storing computer-readable instructions that when executed by the one or more processors, cause the three-dimensional modeling apparatus to, based on a determination that the first three-dimensional model and the second three-dimensional model are interlaced:
perform mesh optimization processing on a first mesh in the first three-dimensional model based on the first layer identifier and the second layer identifier, to obtain a three-dimensional model of the to-be-modeled object,
wherein the mesh optimization processing removes interlacing between the first three-dimensional model and the second three-dimensional model.

19. The three-dimensional modeling apparatus according to claim 11, wherein:
the first depth information of the to-be-modeled object is obtained by performing the depth prediction processing on the first planar image and the second planar image by using a depth prediction model, and
a training process of the depth prediction model comprises:
performing, by the depth prediction model, depth prediction processing on a target pixel point associated with a target object in a training image, to obtain a depth prediction result corresponding to the target pixel point;
predicting a normal vector of each target pixel point based on the depth prediction result of each target pixel point; and
jointly optimizing the depth prediction model based on depth difference information and normal vector difference information, to obtain an optimized depth prediction model,
the depth difference information being obtained based on a difference between the depth prediction result of each target pixel point and an annotation result corresponding to the training image, and the normal vector difference information being obtained based on a difference between the normal vector of each target pixel point and a true normal vector of the target pixel point.

20. A non-transitory computer readable medium storing instructions that when executed by one or more processors, cause the one or more processors to:
obtain a planar image set of a first object element of a to-be-modeled object, the planar image set comprising a first planar image of the to-be-modeled object from a first perspective and a second planar image of the to-be-modeled object from a second perspective that is different from the first perspective;
obtain boundary information of the to-be-modeled object, the boundary information comprising first boundary information of the first object element, the first boundary information comprising first geometric boundary annotation information and second geometric boundary annotation information, the first geometric boundary annotation information indicating a first actual boundary of the first object element of the to-be-modeled object in the first planar image, and the second geometric boundary annotation information indicating a second actual boundary of the first object element of the to-be-modeled object in the second planar image;
perform depth prediction processing on the first planar image and the second planar image, to obtain depth information of the to-be-modeled object, the depth information comprising first depth information of the first object element; and
model the to-be-modeled object based on the boundary information of the to-be-modeled object and the depth information of the to-be-modeled object, to generate a three-dimensional model of the to-be-modeled object.
